(19) United States
(12) Patent Application Publication
(10) Pub. No.: US 2006/0089936 A1
(43) Pub. Date: Apr. 27, 2006

(54) System and method for a secure, scalable wide area file system

(75) Inventor: Tom Chalker, Mount Pearl (CA)

Correspondence Address: Tom Chalker, 17 Bletchley Cres, Mount Pearl, A1N 4V2, CA

(73) Assignee: Tom Chalker, St. John's (CA)

(21) Appl. No.: 11/255,949

(22) Filed: Oct. 24, 2005

(30) Foreign Application Priority Data
Oct. 25, 2004 (CA) 2,483,760

(51) Int. Cl. G06F 17/30

(52) U.S. Cl. 707/10

(57) ABSTRACT

A system and methods are disclosed for providing independent virtual drives of a hierarchical file system across any number of computers within a Wide Area Network such as the Internet such that the number of directories and files within these file system drives is constrained only by the amount of storage system hardware. The system and methods allow many file system drives to occupy the same storage hardware but be totally independent of each other and uniquely identified and privately accessed by a set of encryption keys. The system and methods store the files in these systems as many separate blocks that are distinguished by a unique identity, encrypted locally on the computer equipment during a write operation and are transferred to different computers for storage across a large Peer-to-Peer network. The system and methods transfer these blocks back and decrypt them locally on the computer equipment and reassemble them to reproduce the original file. The system and methods use an algorithm based on a one-way function that is executed locally on the computer equipment performing the read or write operation to determine the identities for each block and decide on which Storage Peer each block will reside. This system and methods provide for a decentralized organization of the files of the file system drive. Access to a file system drive, its directories and files can only be achieved with knowledge of this set of encryption keys. Many independent file system drives, both public and private, coexist on the same distributed storage hardware based on different sets of encryption keys.

### FIELD OF THE INVENTION

The present invention relates generally to computers and computer security. More specifically, a system and method for creating a decentralized Secure File System across a distributed network of peer computers is disclosed.

### BACKGROUND OF THE INVENTION

Consumers of computers create, store and retrieve computer files continuously during the daily operation of their computer equipment. In most cases, the files are placed on the local hard-drive of the computer under the control of the operating system. As sources of data such as digital cameras become richer, large amounts of valuable data are accumulating on these hard-drives. Some users protect this data by employing backup strategies in which this data is written regular to non-volatile storage devices such as DVDs, CR-ROMs, magnetic tape or high volume memory devices. Others, especially in the corporate realm, are members of networks of computers, such as local area networks (LANs), that enable employees and other authorized users within businesses and other organizations to to store their data on corporate file servers and defer the responsibility for the backup of their data to administrative staff.

A file server is defined as a computer that exists within a network of computers that offers regions of is fixed hard drive storage space for the use of other computers in that network. A client of this file space sees a virtual drive in the drive list of their computer interface that operates exactly like the drives formed by the hard disk drives physically present on their computer. Attempts by the user to read or write files in their virtual drive are translated in to requests and data packets that are transmitted from the users computer and the file server to provide directory and file data.

These file-serving solutions are created by tightly-coupled configurations of computers running proprietary or open-source operating systems that don't scale well past a dozen server computers. Increasing capacity often involves integrating many different manufacturers Storage-Attached-Network products. Managing this capacity requires the multiplexing of many network server identities by the client computer. Balancing the storage needs of many clients across the total available server storage space is a difficult task because of a fundamental flaw in the way this low-level hardware storage equipment is organized.

At the lowest level, digital data is stored in fixed-size blocks across the sectors of hard-drives. The nature of these blocks is hidden by the abstraction of the data into variable length files by the operating system. The storage solutions operate exclusively with files of variable length in fixed-size containers that are a sub-set of the total available space of the hard drive and therefore the storage solutions have to predict the storage requirements of individual users. The most common approach involves the setting of arbitrary quotas of maximum space per client which effectively trap unused hard-drive space within each user quota. In some installations, a complex layer of ‘virtualization’ software attempts to compensate for this inefficiency by monitoring the actual file usage and invisibly moving files around on behalf of the user to maximize the usage of a drive. The user is unaware of this and sees what appears to be a static directory of files.

The problems of conventional file-serving are compounded when the users operate from outside the Local Area Network. The basic protocols of these solutions are not suitable for Wide Area Networks, so additional layers of protocol are used to form Virtual Private Networks. (VPNs) A VPN layer of protocol seeks to authenticate a user and then encrypt the channel over which data flows across the WAN thereby granting the user the right to avail of a file-server resource. A VPN essentially extends the authentication domain for the users of a LAN to a wider region that is physically outside that LAN. This extra complexity must be managed by an administrative staff.

Again, at its lowest level, file-serving is flawed. A prohibitory process is used to restrict user access. All of the infrastructure is in place to connect any user to any file but the transaction is prevented at one point in the chain by a single decision (based on an authentication step) that blocks the process. Such designs are inherently susceptible to attack by the attacker who can modify the one critical piece of code in the system to bypass the prohibitory decision. One such malicious modification can allow all users whether they are legitimate or not to begin accessing all files in the system.

There is a need, therefore, for an improved system and method for providing file-server access to large numbers of independent users over a Wide Area Network, as will be described below with reference to the drawings.

### PRIOR ART

This invention builds upon file system technology developed in the 1970s for the abstraction of a hierarchical file-system from mechanical mass-storage media. The first such system was conceived of in 1965 as part of the Multics Operating system being developed by Bell Laboratories in conjunction with MIT and General Electric. Hierarchical file system implementations were also publicly disclosed during the emergence of the Unix operating system in 1969 by AT&T who had earlier dropped out of the Multics project because they were unhappy with the progress being made.

This invention also employs One-Way Algorithms and in particular, Pseudo Random Number Generators that have been released from academia into the public domain. In 1951, Derrick Henry Lehmer invented the linear congruential generator, used in most pseudo-random number generators today.

The first Network File System, NFS, was developed inside Sun Microsystems in the early 1980s. A freely distributable version of NFS, was developed in the late 1980s at the University of California at Berkeley. This invention is a replacement for NFS rather than an adaptation.

### SUMMARY OF THE INVENTION

Accordingly, a system and method for presenting a Secure File System of unlimited capacity and unlimited number of independent virtual drives to users across a WAN are disclosed.

It should be appreciated that the present invention can be implemented in numerous ways, such as the use of different Address Transform algorithms for the creating Block ID and Peer Indices sets which will result in differing overall system behaviors. Several inventive embodiments of the present invention are described below.

The basic structure of the invention consists of the following parts:
1. A software or hardware algorithm that allows a networked computer (hereafter called a Storage Peer) to respond to a request to store or retrieve a block of data based on a name that is unique for that block when it is stored on that computer.
2. Software on a computer or workstation in the same network (hereafter known as the Client Peer) that coordinates the identities of the Storage Peers and presents the semantics of a Secure File System with many independent sub-sections of the file space (hereafter known as a “Virtual Drive” or just “Drive”) to the Operating System or application programs of that computer.
3. A software or hardware algorithm (hereafter known as the Address Transform) that translates a request to read or write a file in a file system identified by a set of encryption keys (hereafter known as the Personal Encryption Code or PEC) into a set of block storage or retrieval requests made of many different Storage Peers. The Address Transform does not require any centralized transaction to manage any number of Drives or files within each Drive.

In one embodiment, the Address Transform uses a Pseudo Random Number Generator (PRNG). A seed is calculated from a Cyclical Redundancy Check (CRC) of the fully-qualified path and file name of a file and the Location Key from the PEC. Although the sequence of numbers extracted from a PRNG appear to be random, this exact same sequence of numbers may be generated from a PRNG that is seeded with the same value. This sequential set of numbers is used to calculate the 64 bit Block IDs and 32-bit Peer Indices that are used to interact with the Storage Peers for each block. As the inputs to the PRNG are the same during the reading and writing of a specific file in a drive, the sequence of Block IDs and Peer Indices can be reproduced to read a previously written file. The mathematical properties of the PRNG guarantees a uniform distribution of random number values and therefore a uniform distribution of Storage Peer Indices causing storage to be balanced.

In another embodiment, the Address Transform uses a cryptographic hash function that has the fully qualified path and file name of a file, the Location Key from the PEC and a linear monotonic series as inputs from which a set of 64 bit Block IDs and 32-bit Peer Indices are calculated. Such a sequence as generated during writing would be reproducible during reading and the mathematical properties of the hash function would produce a uniform distribution of Storage Peer Indices.

In another embodiment, the Address Transform is based on a heuristic allocation algorithm that chooses Storage Peer Indices based on knowledge of the current free space remaining on each of the Storage Peers. Such a embodiment might require a reporting function to exist on the Storage Peers and the storage of a snapshot of the status of the Storage Peers at the time of writing to be stored within the distributed network. The allocation algorithm would choose the Storage Peer Indices such that a balance would be achieved over time.

These and other features and advantages of the present invention will be presented in more detail in the following detailed description and the accompanying figures, which illustrate by way of example the principles of the invention.

### BRIEF DESCRIPTION OF THE DRAWINGS

FIG. 1 is a block diagram of a general purpose computer system suitable for carrying out the processing in accordance with one embodiment of the present invention;

FIG. 2 is a schematic diagram of a the overall system of peer computers used in one embodiment to provide computer security;

### DESCRIPTION OF THE INVENTION

A detailed description of a preferred embodiment of the invention is provided below. While the invention is described in conjunction with that preferred embodiment, it should be understood that the invention is not limited to any one embodiment. In actual fact, the scope of the invention is limited only by the appended claims and the invention encompasses numerous alternatives, modifications and equivalents. For the purpose of providing an example, many specific details to a preferred embodiment are set forth in the following description in order to provide a thorough understanding of the present invention. Other potential embodiments are referenced to improve understanding. The present invention may be practiced according to the claims without some or all of these specific details. For the purpose of clarity, technical material that is known in the technical fields related to the invention has not been described in detail so that the present invention is not unnecessarily obscured.

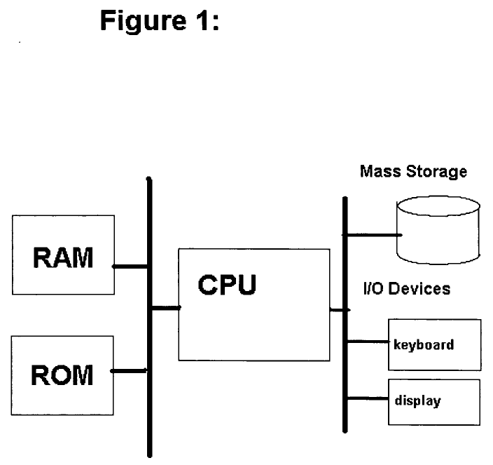

FIG. 1 is a block diagram of a general purpose computer system suitable for executing the function of a Storage Peer or a Client Peer in accordance with any embodiment of the present invention. FIG. 1 illustrates one embodiment of a general purpose computer system. Other computer system architectures and configurations can be used for carrying out the processing of the present invention. The computer system depicted in FIG. 1 is made up of a number of subsystems as described below, and includes at least one microprocessor subsystem (also known as a central processing unit, or CPU). The CPU is a general purpose digital processor which executes the Fetch/Execute/Cycle algorithm to control the operation of the computer system. Binary instructions are fetched from memory, decoded by the logic of CPU and used to manipulate the numbers in its registers and modify the sequence of execution. Pre-stored programs cooperate with the stored operating system to accept input data, and generate output and display of data on output devices.

The CPU is connected to a digital bus on which there is also random access memory (RAM), and read-only memory (ROM). The ROM is used to coordinate the boot-strapping of the computer. The RAM operates as primary storage for programming instructions and data for processes operating on CPU. The primary storage typically holds basic operating instructions, program code, data and objects used by the CPU to perform its functions. The CPU can also directly and very rapidly retrieve and store frequently needed data in a cache memory (not shown) to improve throughput.

Mass storage devices provide secondary data storage capacity for the computer system, and are coupled through dedicated interface electronics to the same bus as the CPU. The primary mass storage device is usually a fixed hard disk drive. It is a high-capacity device that can store in excess of 40 Gigabytes of data and is capable of both reading data and writing data. Some other mass storage devices commonly known as a CD-ROMs are removable and are read-only. Storage may also include computer-readable media such as magnetic tape, flash memory, portable mass storage devices, holographic storage devices, and other storage devices. Mass storage devices generally store additional programming instructions, data, and the like that typically are not in active use by the CPU.

In addition, the bus on which the CPU resides can be used to provide access other subsystems and devices as well. In the described embodiment, these can include a video card that provides output to a display monitor, a network interface, a keyboard, and a pointing device as well as an auxiliary input/output device interface, a sound card, speakers, and other subsystems as needed. In some embodiments of this processing hardware, all of the basic devices and their interface electronics are packaged on a single motherboard. The pointing device is usually a mouse but may be other devices that provide two-dimensional input data such as a stylus, track ball, or tablet. These devices provide means to control a graphical user interface. A graphical user interface may be redundant for the purposes of executing the functions of the Storage Peer or the Client Peer but may still serve to simplify the administration of these computers.

The network interface allows the CPU to be coupled to other computers in a network or to a telecommunications network using a network connection as shown. Through the network interface, the CPU might receive information, e.g., data objects or program instructions, from another computer on the network, or might output information to another computer network in the course of executing user programs or Operating System functions. Information, often represented as a collection of bits within a computer File, may be received from and outputted to another computer on the network, through various implementations of network interface hardware.

The computer system shown in FIG. 1 is but one example of a computer system suitable for use with the invention. Other computer systems suitable for use with the invention may include additional or fewer subsystems. In addition, there may be other schemes employed to link subsystems other that the digital bus. Other computer architectures having different configurations of subsystems may also be utilized.

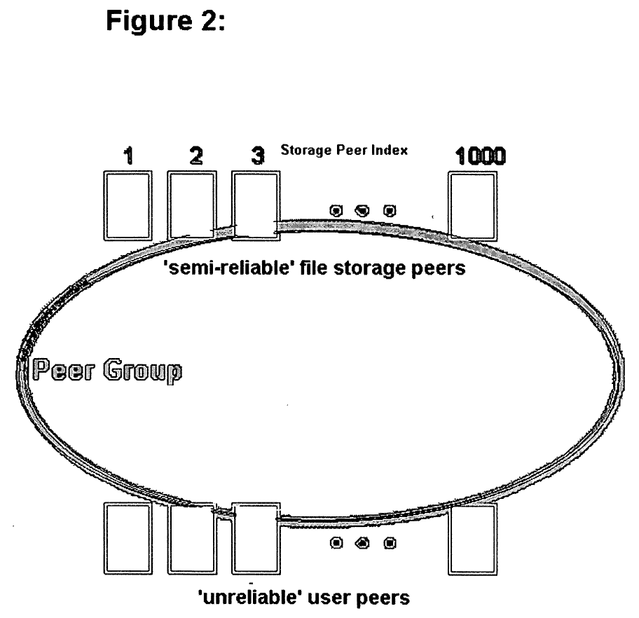

FIG. 2 is a schematic diagram of a system used in one embodiment to provide a Secure File System for a large number of users whose computer equipment is distributed over a large geographical area. The blocks on the top of FIG. 2 represent many similar general purpose computer systems as described above. The only common characteristics of these computer systems is the large total amount of fixed hard drive capacity that each possesses and the fact that they all have network interfaces. Typically, each computer would have a minimum of 300 GBytes of hard drive space and in many cases they would have in excess of 1 TByte (1 Tbyte=1000 GBytes) of space. Collectively, these computers as represented by the blocks in the top of FIG. 2 would represent the Storage Peers of the the present invention. It is expected that these Storage Peers would remain powered up and operational every day and for all but 30 minutes of a typical day. These machines are considered to be “semi-reliable peers” and serve as a resource for all users of the Secure File System. In one embodiment of the invention, a minimum of six computers operating as Storage Peers would be required to operate the solution but the maximum number of computers would be unbounded.

The architecture of an embodiment of the inventive system has blocks as represented on the bottom of FIG. 2 that represent the computers or workstations operated by the users of the Secure File System. These blocks represent general purpose computer systems as described above. These computers are known as the Client Peers and have the only distinguishing collective characteristic of possessing network interface cards. The Client Peers of such an inventive system represent a wide range of commercially available computer equipment and installed Operating Systems. There is no restriction on the length of time a Client Peer remains powered up. These machines are considered to be “unreliable peers” that do not provide a collective resource for the other users of the Secure File System.

The circle in FIG. 2 that intersects the blocks defined as Storage Peers and Client Peers represents one Peer Group of a Peer-to-Peer network that forms a logical grouping of the computer in one embodiment of the invention. The Peer-to-Peer software that executes on each of these computers permits the functions of 1) allowing these computers to join this Peer Group and 2) passing broadcast or unicast messages exclusively within that Peer Group. The messages that are passed define the health of the Storage Peers within the Peer Group. For example, a specific message is broadcast on a regular basis to all Storage Peers within the Peer Group to ascertain that all known Storage Peers are currently operating. Other messages inform the Peer Group that a new Storage Peer has joined. The collective status of the Peer Group is encapsulated by the ‘generation’ parameter which defines the number of active Storage Peers in the system at any given instant.

The Process of Writing a File From the Secure File System in One Embodiment of the Invention is Described as Follows:

An embodiment of the inventive system will respond to a request to write a file by reacting to operation by the user of the controls of an application program or Operating System function executing on a specific Client Peer. The system must be aware of the user's choice of a specific Drive known to the computer and choice of a fully-qualified pathname which is defined by the sequence of directories from the top of the Drive down to and including the name of the filename.

At the instant the file write is requested, the software on the Client Peer of an embodiment of the inventive system must determine the number of Storage Peers that are currently active within the Peer Group. This information is encapsulated by looking up the current ‘generation’ count which is an integer that specifies a stable population of Storage Peers. The Client Peer software will use the knowledge of the requested Drive to lookup the PEC corresponding to that drive. The Location key of the PEC and the fully-qualified pathname will be applied to the Address Transform thus preparing the Address Transform to produce a series of Block ID and Storage Peer Index sets that define the positions of each block within the space defined by the population of the Storage Peers. In such an embodiment of the inventive system, the algorithm of the Address Transform influences the period of this calculation and ensures that the sequences Block ID and Storage Peer Index sets does not repeat within the largest file that could be practically saved within the entire Secure File System. In one embodiment of the invention, three or more redundant positions are calculated for each block with mutually-exclusive Peer Indices.

The system, in accordance with the invention, will allow data to be written to the Client Peer software from the application program, applied to a compression engine, sliced into blocks, and encrypted indirectly from the Content Key of the PEC. A Block ID and Storage Peer Index set is obtained from the Address Transform. The Storage Peer Index is dereferenced to determine the associated Storage Peer and a request is made to that peer to store a block with that Block ID. If the Storage Peer does not have a pre-existing block of that identity, the storage is performed and acknowledged. Further blocks and their copies are cut and stored until the data from the application program is exhausted. Once this write is completed, the Block ID and Storage Peer Index calculations from the Address Transform are discarded.

In such an inventive embodiment, the Storage Peer which detects a previously stored block of the same Block ID as requested during a write operation will respond with a negative acknowledgment. This forces the Client Peer software to record the transaction as a collision. In one embodiment, the software on the Client Peer would extract a new Block ID and Storage Peer Index from the Address Transform and attempt to store the block in a new position. Other embodiments could react differently, but must allow the file write operation to continue to its conclusion.

After a file has been written, the system in accordance with the invention, will update the corresponding entry in the File Allocation Table (FAT) of is parent directory to reflect the presence of that file, its last-modified timestamp of that file and the generation that existed at the time of writing. This FAT is then stored within the Secure File System in the same fashion as a normal data file. In one embodiment of the invention, all the parent FATs that make up the directories of the fully-qualified pathname of the file have their last-modified timestamp up to and including the root FAT. This permits changes to the Secure File System to be detected on other Client Peers (who have been granted copies of the appropriate PEC) by regularly polling the root FAT for changes.

In one embodiment of the invention, an exclusive file-locking scheme is achieved by setting a Write-Lock flag in the entry corresponding to the file in the parent FAT before writing a file and resetting this flag during the post-write update of the parent FAT. During this process, all other Client Peers are prevented from obtaining a Write-Lock on that file or writing its contents.

The Process of Reading a File from the Secure File System in One Embodiment of the Invention is Described as Follows:

The user requests that a file be read by operating the controls of an application program or Operating System function executing on a specific Client Peer. The user chooses a specific Drive known to the computer and selects a fully-qualified pathname which is the sequence of directories from the top of the Drive down to and including the name of the filename.

The software on the Client Peer of the inventive system ascertains the number of Storage Peers that were active within the Peer Group during the writing of the file by retrieving the ‘generation’ of the file from the specific entry for that file in its parent FAT. This ‘generation’ count is an integer that specifies a stable population of Storage Peers. The Client Peer software uses the knowledge of the requested Drive to lookup the PEC corresponding to that drive. The Location key of the PEC and the fully-qualified pathname are applied to the Address Transform. A series of Block ID and Storage Peer Index sets are created that define the position of each block within the space defined by the populations of the Storage Peers. In one embodiment, three or more Block ID and Storage Peer Index sets may be created for each block representing redundant storage of data.

The system, in accordance with the invention, will allow data to be requested from the Client Peer software by the application program at which point a set of Block ID and Storage Peer Index data will be obtained from the Address Transform. The Storage Peer Index is dereferenced to determine the associated Storage Peer and a request is made to that peer to obtain a block with that Block ID. If the Storage Peer has a pre-existing block of that identity, the block is transferred and acknowledged. Upon arrival at the Client Peer, the block is decrypted indirectly from the Content Key of the PEC. The block is applied to a decompression engine and the decompressed data is made available to the application program.

The inventive system permits further blocks to be requested and retrieved until the requests from the application program are exhausted. Should the application program request more data than can be provided by the retrieval of blocks as specified by the Address Transform, an error message will be presented to the application program. Note that in one embodiment, redundant copies of each block that were stored during a writing operation are available in the case the failure of a Storage Peer in the time interval since that write operation.

All embodiments of the invention avoid the inefficiencies of conventional file-serving systems by allowing blocks that represent and number of Drives or files within those Drives to be stored anonymously and uniformly across many Storage Peers. Each Storage Peer will be filled with blocks equally, and the only parameter that will need to be monitored on such a Peer will be total space used, which is of course, independent of the individuals using the storage system by virtue of the anonymity of those blocks.

All embodiments of the invention do not suffer from the inherent susceptibility of conventional file-serving designs to code-modification attack because the process of reading a file as described for this invention requires the pro-active use of a Personal Encryption Code to find all of the blocks belonging to that file. No alteration of the program code on a Storage Peer or a Client Peer can allow an attacker to obtain a file from the network of Storage Peers for which the PEC is not known. The theft of a PEC from a user will compromise the files of the Drive for that user, but it will not place in jeopardy any of the files stored through this invention by a different PEC.

It can be understood from the previously documented accounts of the writing and reading from the example Secure File System embodiment that the claimed mechanism of breaking a file into small blocks, encrypting them and using the Address Transform to locally generate, without a centralized transaction, the identities of the blocks (the Block IDs) and their ultimate storage position (the Peer Indices) across a large network, can render the process of retrieving these blocks and rebuilding the file without access to the PEC that effected the write operation, to be prohibitively difficult for an malevolent outsider, if, as is claimed, the embodiment employs the use of effective one-way algorithms. This patent claims any embodiment that uses any combination of these techniques to deter an unauthorized observer from compromising the files stored on such a Secure File System.

In can also be understood from the previously documented behavior of the Address Transform that any number of Drives may co-exist independently, realize a fully hierarchical system of directories and files and enjoy complete privacy within the collective storage space of a distributed Secure File System by operating on a unique set of encryption keys that form the Personal Encryption Code. (PEC) This patent claims any embodiment that uses a locally generated sequence of block identities (Block IDs) and storage positions (Peer Indices) to permit the storage files or blocks of files in mutually-exclusive positions within a larger aggregation of digital file space.

It can also be understood from the previously documented behavior of the Address Transform that the use of an algorithm that produces a suitably uniform distribution of storage positions (Peer Indices) across a population of Storage Peers will result in an efficiently balanced use of the storage capacities of those Storage Peers. This patent claims any embodiment that uses the predictably uniform distribution of the execution of the outputs of a mathematical function executed many times as the basis for the allocation of the storage of files or blocks of files to achieve storage efficiency.

What is claimed is:

1. A system for providing many independent hierarchical file storage areas (hereafter known as “Drives”) within a large organization of computing devices (hereafter known collectively as a “Secure File System”) over a Wide Area Network, comprising of the following three components:
a) a set of networked computers (hereafter called “Storage Peers”) than run software to accept requests to store or retrieve data blocks based on a unique identity (hereafter called a “Block ID”) of the block; and
b) a set of networked computers or workstations (hereafter called “Client Peers”) that run software to manage a file system and make requests from Storage Peers on the same network to store or retrieve data blocks to save or read files from that Secure File System; and
c) a software or hardware algorithm (hereafter called an “Address Transform”) that uses knowledge of a set of encryption keys associated with a specific Drive to deterministically specify a Block ID and Storage Peer identity (hereafter called a “Storage Peer Index” or just a “Peer Index”) for each block of a specific file for the purposes of placing each block named by the Block ID on a Storage Peer referenced by the Peer Index such that each block has a very high probability of being stored in a unique place across the full collection of Storage Peers. A major characteristic of this algorithm is the fact that the Block ID and Peer Indices for each block of the file can be calculated locally on the Client Peer without requiring a transaction from a centralized authority.

2. The system as recited in claim 1, in which the blocks are fixed in size to optimize the storage of blocks within the fixed sector size of a hard drive to prevent hard drive file fragmentation.

3. The system as recited in claim 1, wherein the organization of the files within a Drive of the Secure File System is managed as a hierarchical system of directories based on the use of File Allocation Tables (FAT) stored in the same manner as other files in the Secure File System such that the user of the Secure File System can navigate to any directory within a Drive of the Secure File System and find or operate upon a collection of unique files.

4. The system as recited in claim 3, wherein the FATs that describe hierarchical system are also used to track and compensate for the calculation by the Address Transform of Block ID and Peer Index combinations that are not unique for two or more different combinations of file names and Drives within the Secure File System. Such conflicting combinations are known as ‘collisions’.

5. The system as recited in claim 4, wherein artificial collisions are introduced into the collision tracking mechanism to deliberately hide the presence of files or to create hidden directories of files for the purpose of granting temporary access to a set of directories or files.

6. The system as recited in claim 1, wherein a one-way function or one-way algorithm is used by the Address Transform to calculate the Block IDs and Storage Peer Identities such that the full sequence of these entities cannot be deduced from knowledge of a sub-set of these entities.

7. The system as recited in claim 6, wherein a Pseudo-Random Number Generator is used as the basis of the one-way algorithm of the Address Transform.

8. The system as recited in claim 1, wherein the algorithm that calculates the set of Block IDs and Peer Indices is based on discrete intervals of time, known as generations, in which the population of Storage Peers is static and known to all Client Peers.

9. The system as recited in claim 8, wherein the algorithm allows Storage Peers to be added or removed to create new generations and in which the number of Storage Peers may been increased without limit.

10. The system as recited in claim 1, wherein the algorithm of the Address Transform to calculate the set of Block IDs and Storage Peer Identities produces a uniform distribution of Storage Peer Identities such that the population of blocks stored across the network of Storage Peers is also uniformly distributed and that the storage requirements of the Storage Peers are balanced equally across the population of Storage Peers.

11. The system as recited in claim 1, where Cyclic Redundancy Checks (CRC) are calculated for each block before transmission and compared against CRCs calculated for each previously stored block before they are overwritten on a Storage Peer as a means to prevent the corruption of files that are simultaneously written by two or more Client Peers.

12. The system as recited in claim 1, further comprising a user interface, wherein a Drive of the Secure File System is displayed in a graphical manner and allows a user to operate with the Drives or the Secure File System in the same fashion as other local or remote file systems.

13. The system as recited in claim 9, further comprising a user interface, wherein the Secure File System status is presented in a graphical manner and allows a user to manage many Drives of the Secure File System based on different encryption key sets associated with each Drive and which allows the user to observe how the blocks particular files are distributed across the network of Storage Peers.

14. The system as recited in claim 1, further comprising a method which will randomize the order in which blocks are delivered to the respective Storage Peers.

15. The system as recited in claim 3, further comprising a technique of achieving exclusive locks also known as write-locks that prevent the simultaneous writing of files with a Drive of the Secure File System by setting a Write-Lock flag for a file entry in the parent FAT entry before attempting to write and resetting the Write-Lock flag for the entry in the parent FAT when the write is completed.

16. The system as recited in claim 1, in which redundant copies of each block are stored across the Storage Peers such that the data of a block may be recovered from a redundant copy should one or more Storage Peers fail.
